(19) United States
(12) Patent Application Publication
(10) Pub. No.: US 2007/0079675 A1
(43) Pub. Date: Apr. 12, 2007

(54) Housing body

(76) Inventor: Maximilian Kronberger, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/470,028

(22) Filed: Sep. 5, 2006

(30) Foreign Application Priority Data
Sep. 6, 2005 (EP) 05019334

(51) Int. Cl. B26D 7/08

(52) U.S. Cl. 83/22

(57) ABSTRACT

A housing body (18) made from an invar alloy, with a recess (19) to accommodate a component (16) made from a material different from the invar alloy, has a thermal expansion coefficient that is approximately identical to that of the invar alloy. The housing body (18) has a cavity (24), which is produced by means of a cutting method and to which a high-pressure fluid can be fed in the required manner.

### PRIORITY

This application claims priority from European Patent Application No. EP05019334, which was filed on Sep. 6, 2005, and is incorporated herein by reference in its entirety.

### TECHNICAL FIELD

The invention relates to a housing body made from an invar alloy, an actuator unit for an injection valve with a housing body and an injection valve.

### BACKGROUND

Invar alloys are a group of alloys and compounds, which have the characteristic of having very small positive or partially negative thermal expansion coefficients in certain temperature ranges. The name results from the invariance of expansion in respect of a temperature change. Invar has a high mechanical strength and can be welded. One frequently used invar alloy is an FeNi alloy with a nickel content of 36% nickel. Alloying with 5% cobalt allows the thermal expansion coefficient to be reduced further. Many further alloys are also known, with which an invar effect occurs.

Known devices for a housing body made from an invar alloy are disclosed in DE 195 40 155 A1 and DE 101 49 915 A1.

DE 195 40 155 A1 shows a servo valve for an injection nozzle, with a housing body made from an invar alloy, with a recess for a piezo-actuator, having a thermal expansion coefficient that is approximately identical to that of the invar alloy, and a supply line, to which a high-pressure fluid can be fed.

DE 101 49 915 A1 discloses a fuel injection valve for fuel injection units in internal combustion engines. It has a compensating sleeve with an actuator chamber to accommodate an actuator and an intake opening, via which fuel can be fed to a valve sealing seat. The compensating sleeve is made from an invar alloy.

Housing bodies made from an invar alloy, e.g. housing bodies for an actuator unit of an injection valve in an internal combustion engine, have the advantage that a change in temperature only produces a small change in the length of the housing body. Components inside the housing body, which themselves are subject to no or only a small change in length, thus generally have no or only little mechanical stress in relation to the housing body. As housing bodies are generally required to combine an increasing number of functions, it is the intention that housing bodies made of invar alloys should also take on further roles in addition to the functions resulting from the small temperature-dependent length change.

The object of the invention is to create a housing body made from an invar alloy, an actuator unit for an injection valve with a housing body and an injection valve, each allowing reliable and precise function with a small number of components.

### SUMMARY

According to a first aspect, a housing body is made from an invar alloy, with a recess for accommodating a component made from a material that is different from the invar alloy, having a thermal expansion coefficient that is approximately identical to that of the invar alloy, and a cavity, which is produced by means of a cutting method and to which a high-pressure fluid can be fed in the required manner.

A maximum pressure can be determined in each instance from the material data of the invar alloy used for the housing body under certain basic geometrical conditions, for example as a function of the distance between the recess for accommodating the component and the cavity and the width of the cavity opening, to which pressure the cavity can be subjected to ensure continuous operation. Surprisingly it has proven that the cavity of the housing body, which is made from such an invar alloy, can also be operated reliably in a continuous manner under the same basic geometrical conditions even for pressures above the arithmetically determined maximum pressure. High pressure here means any pressure, which is above the maximum pressure determined arithmetically as described.

The reason for the increased compressive strength of the cavity is that, when the cavity is configured by means of a cutting method, wall regions of the housing body, which are adjacent to the cavity, are subject to plastic deformation, as a result of which internal compressive stresses are established in these wall regions of the housing body. If a fluid at a pressure that is also significantly higher than the maximum arithmetically determined pressure then acts on the cavity, the internal compressive stresses in the wall regions of the housing body counteract the compressive forces of the fluid. The cavity can thus be subjected to pressures, which can be significantly greater than the maximum arithmetically determined pressure.

It is advantageous if both the component and the cavity with high pressure resistance can be disposed in a single housing body in the housing body made from invar, which has a very low thermal expansion coefficient and can thus compensate for thermal length changes in the component. It is also advantageous if multifunctional housing bodies can be lighter in weight as this means that additional components, for example components for connecting a number of housing body elements, do not have to be used.

In one advantageous embodiment of the invention the invar alloy has a mean thermal expansion coefficient of maximum 2*10⁻⁶/K in the temperature range of 25° C.-100° C. Invar alloys with such a low thermal expansion coefficient are for example FeNi alloys with a nickel content of around 36%, which are readily available and are therefore frequently used in the corresponding technical applications.

In a further advantageous embodiment of the invention the cavity has a wall and a fluid acts on the cavity at least once for a predetermined time period at such a pressure that the yield point of the invar alloy is exceeded in the region of the wall. This measure increases the strength of the cavity further. The action of such a pressure causes the wall regions of the cavity to be subject to plastic deformation and, when the action of the pressure ceases, internal compressive stresses are present in the sections of the housing body adjacent to the wall regions of the cavity, which are greater than the internal compressive stresses established solely by the production of the cavity by means of the cutting method. It is particularly advantageous, if a fluid at a pressure of at least 2500 bar acts on the cavity at least once for a predetermined time period. The yield point of invar alloys can be exceeded at this pressure.

In a further advantageous embodiment of the invention the cutting method is drilling, milling, grinding or honing. These methods can be used in a particularly simple manner to produce the cavity in the housing body.

In a further advantageous embodiment of the invention the cavity has a cylindrical cross-section. This is a cavity that is particular simple to produce in the form of a cylindrical drilled hole.

According to a second aspect, in an actuator unit for an injection valve, with a housing body, it is possible to link the cavity hydraulically to a high-pressure fluid circuit so that a fluid can be fed.

The use of an invar alloy for the housing body of the actuator unit of an injection valve, in which the high-pressure resistant cavity is also disposed, allows a very compact design of the actuator unit, as the housing body is made from a single material and can therefore be executed as a single piece. A configuration of the housing body, which increases the geometrical dimensions of the actuator unit by comprising two housing body sections of optionally different materials and then possibly also requiring the use of connecting elements which take up further space, can thus be avoided.

The use of a housing body made from an invar alloy, in which the high-pressure resistant cavity is also disposed, also allows an improved pressure seal to be achieved between the actuator unit and the components of the injection valve adjacent to the actuator unit. This is on the one hand because, with the otherwise general use of components made from materials of differing rigidity and differing thermal expansion coefficient, mechanical stresses can occur between the components, which can result in a poorer fit between the actuator unit as a whole and the components of the injection valve adjacent to the actuator unit. On the other hand the invar alloy is a material that can be subjected relatively easily to plastic deformation for the single-piece housing body, allowing easy fitting of the housing body to the components of the injection valve adjacent to the actuator unit.

In a further advantageous embodiment of the invention the component is an actuator. It is particularly preferably for the actuator to be a piezo-electric actuator.

According to a third aspect, in an injection valve with a nozzle assembly and an actuator unit, the nozzle assembly and the actuator unit being linked together.

By configuring the housing body from an invar alloy, in which the high-pressure resistant cavity is also disposed, it is possible to reduce the electrical energy required for the actuator unit for a required displacement of a nozzle needle of the nozzle assembly. If additional components made from materials of differing rigidity and differing thermal expansion coefficient were used, it would not be possible to integrate these so favorably in the flow of force from the actuator unit to the nozzle needle. The actuator unit would then have to carry out deformation work for the additional components, requiring a greater expenditure of electrical energy for the actuator unit.

### BRIEF DESCRIPTION OF THE DRAWINGS

Exemplary embodiments of the invention are described in more detail below with reference to the schematic drawings, in which:

FIG. 1 shows a cross-section through a housing body and

FIG. 2 shows a longitudinal section through an injection valve with an actuator unit.

### DETAILED DESCRIPTION

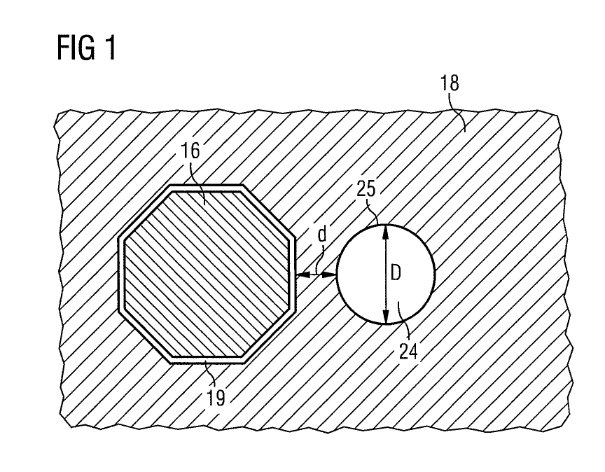

FIG. 1 shows a schematic view of a section of a housing body 18. The housing body 18 is made from an invar alloy. The housing body 18 has a recess 19, in which a component 16 is disposed. A cavity 24 is disposed at a distance d from the recess 19. The recess 19 is shown here with an octagonal cross-section but it can have any other form of cross section. The cavity 24 is shown here with a circular cross-section of diameter D but it can also have any other form of cross-section.

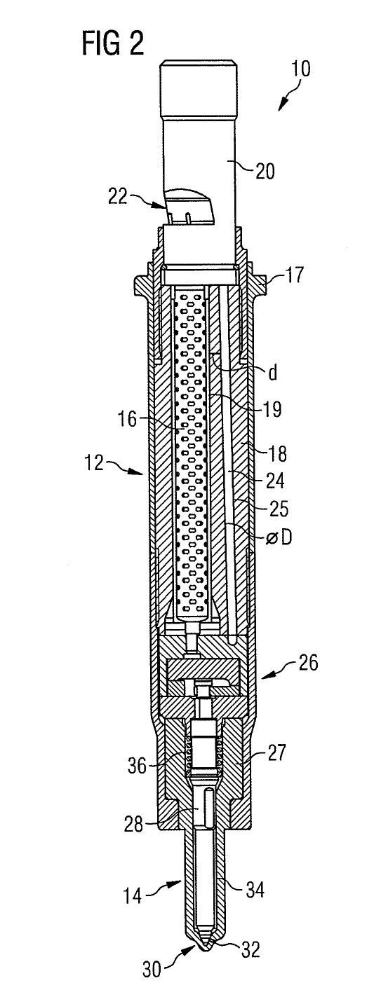

FIG. 2 shows an injection valve 10 with an actuator unit 12 and a nozzle assembly 14. The actuator unit 12 and the nozzle assembly 14 are linked together by means of a nozzle coupling nut 17. The component 16 configured as an actuator is disposed in the actuator unit 12. The actuator can in particular be configured as a piezo-actuator with a stack of piezo-elements and can change its axial expansion as a function of an applied electrical voltage. The electrical voltage is applied to the actuator via a connector socket 22. The actuator is linked to a transformer unit 26, which is disposed between the actuator unit 12 and the nozzle assembly 14.

The injection valve 10 also comprises a fluid connector 20, via which the injection valve 10 is linked in the assembled state to a high-pressure fluid circuit (not shown).

The nozzle assembly 14 comprises a nozzle body 27 with a nozzle body recess 34. A nozzle needle 28 is disposed in the nozzle body recess 34. Regions of the nozzle needle 28 are held in the nozzle body recess 34. It is also pretensioned by means of a nozzle spring 36 such that it prevents the flow of fluid through an injection nozzle 32 disposed in a nozzle bowl 30, when no further forces act on the nozzle needle 28.

The recess 19 and cavity 24 with a wall 25 are disposed in the housing body 18 of the actuator unit 12. Fluid can flow through the cavity 24 out of the high-pressure circuit via the fluid connector 20 to the nozzle assembly 14. In the case of diesel internal combustion engines the fluid pressures are 2000 bar and more. Such high pressures place very high demands on the material of the housing body 18 and the design of the cavity 24.

The housing body 18 is made from an invar alloy with a nickel content of approx. 36%. In addition to FeNi alloys, which optionally also have cobalt alloy elements, the following alloys can also be considered for invar: FePt, FePd, FeMn, CoMn, FeNiPt, FeNiMn, CoMnFe, CrFe, CrMn, CoCr, FeB, FeP, TiFe2, ZrFe2, RECo2 (RE=rare earths except Eu), FeC, Dy2(FeCo)17.

The cavity 24 with a cylindrical cross-section of diameter D is incorporated into the housing body 18 by drilling.

In the housing body 18 of the injection valve 10 shown here the distance d between the recess 19 of the housing body and the cavity 24 in the minimum instance is only approx. 1.85 mm. The diameter D of the cylindrical cavity 24 is around 2 mm. In general the distance d between the recess 19 of the housing body and the cavity 24 and also the diameter D of the cylindrical cavity 24 can be between 1 mm and 3 mm. Under such geometrical conditions the material data of the invar alloy used for the housing body 18 allow it to be anticipated that a pressure of up to maximum 2000 bar can be applied permanently to the housing body 18. However it has surprisingly proven that the housing body 18 with such an invar alloy can also be operated reliably in a continuous manner for pressures of much more than 2000 bar under these basic geometrical conditions. The reason for this is that during the configuration of the cavity by drilling or another cutting method such as milling, grinding or honing, the wall 25 of the cavity 24 is subject to plastic deformation, as a result of which internal compressive stresses are established in the wall 25 of the cavity 24. If a fluid also at a pressure of much more than 2000 bar now acts on the cavity 24, the internal compressive stresses in the wall 25 of the cavity 24 counteract the compressive forces of the fluid. In experiments it has been possible to prove a fatigue strength up to 2600 bar during ten million load changes.

By using the housing body 18 made from an invar alloy, in which the cavity 24 is disposed, it is possible to achieve an improved pressure seal between the actuator unit 12 and the transformer unit 26. This is due on the one hand to the fact that with the otherwise general use of components made from materials of differing rigidity and differing thermal expansion coefficient, mechanical stresses can occur between the components, which can result in a poorer fit between the actuator unit 12 as a whole and the transformer unit 26. On the other hand the invar alloy is a material that can be subjected relatively easily to plastic deformation for the single-piece housing body 18, allowing easy fitting of the housing body 18 to the transformer unit 26.

Also the single-piece configuration of the housing body 18, in which the cavity 24 is disposed, allows the electrical energy required for the actuator for a required displacement of the nozzle needle 28 to be reduced. When using additional components made from materials of differing rigidity and differing thermal expansion coefficient, it would generally not be possible to integrate these so favorably in the flow of force from the actuator unit 12 to the transformer unit 26. The actuator would therefore have to carry out deformation work for the additional components, requiring a greater expenditure of electrical energy for the actuator.

What is claimed is:

1. A method for producing a housing body made from an invar alloy, comprising
accommodating a component made from a material that is different from the invar alloy in a recess of the housing body, the recess having a thermal expansion coefficient that is approximately identical to that of the invar alloy and
producing a cavity by means of a cutting method, wherein a high-pressure fluid can be fed to the cavity,
wherein the cavity has a wall and wherein the fluid acts on the cavity at least once for a predetermined time period at such a pressure that the yield point of the invar alloy is exceeded in the region of the wall.

2. A method according to claim 1, wherein a fluid at a pressure of at least 2500 bar acts at least once for a predetermined time period on the cavity.

3. A housing body, comprising a recess accommodating a component made from a material that is different from the invar alloy, the recess having a thermal expansion coefficient that is approximately identical to that of the invar alloy, and
a cavity through which a high-pressure fluid can be fed,
wherein the cavity has a wall and wherein the fluid acts on the cavity at least once for a predetermined time period at such a pressure that the yield point of the invar alloy is exceeded in the region of the wall.

4. A housing body according to claim 3, wherein the invar alloy has a mean thermal expansion coefficient of maximum 2*10⁻⁶/K in a temperature range of 25° C.-100° C.

5. A method according to claim 1, wherein the cutting method is drilling, milling, grinding or honing.

6. A housing body according to claim 3, wherein the cavity has a cylindrical cross-section.

7. An actuator unit for an injection valve, with a housing body according to claim 3, wherein the cavity is hydraulically linked to a high-pressure circuit to supply a fluid.

8. An actuator unit for an injection valve according to claim 7, wherein the component is an actuator.

9. An actuator unit for an injection valve according to claim 8, wherein the actuator is a piezo-electric actuator.

10. An injection valve with a nozzle assembly and an actuator unit according to claims 7, wherein the nozzle assembly and the actuator unit are linked together.

11. A housing body, comprising a recess accommodating a component made from a material that is different from the invar alloy, the recess having a thermal expansion coefficient that is approximately identical to that of the invar alloy, and
a cavity through which a high-pressure fluid can be fed,
wherein the cavity has a wall wherein the wall has been treated by a fluid that acted on the cavity at least once for a predetermined time period at such a pressure that the yield point of the invar alloy is exceeded in the region of the wall.

12. A housing body according to claim 11, wherein the invar alloy has a mean thermal expansion coefficient of maximum 2*10⁻⁶/K in a temperature range of 25° C.-100° C.

13. A housing body according to claim 11, wherein the cavity has a cylindrical cross-section.

14. An actuator unit for an injection valve, with a housing body according to claim 11, wherein the cavity is hydraulically linked to a high-pressure circuit to supply a fluid.

15. An actuator unit for an injection valve according to claim 14, wherein the component is an actuator.

16. An actuator unit for an injection valve according to claim 15, wherein the actuator is a piezo-electric actuator.

17. An injection valve with a nozzle assembly and an actuator unit according to claims 14, wherein the nozzle assembly and the actuator unit are linked together.
